(19) United States
(12) Patent Application Publication
(10) Pub. No.: US 2002/0000737 A1
(43) Pub. Date: Jan. 3, 2002

(54) Actuation arrangement for hinged components of vehicle tops

(76) Inventors: Wolfgang Kladiwa, Huglfing (DE); Anton Hollerbach, Schongau (DE); Klaus Stolle, Schwabniederhofen (DE)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 09/867,712

(22) Filed: May 31, 2001

(30) Foreign Application Priority Data
May 31, 2000 (AT) A 959/2000

(51) Int. Cl. B60J 7/12

(52) U.S. Cl. 296/107.01

(57) ABSTRACT

An actuation arrangement for hinged components of vehicle tops, particularly convertible top hoops or covers for convertible tops, whereby the hinged components are pivotably mounted on the vehicle on at least one main bearing and whereby the actuation arrangement has at least one direct or indirect rotary drive engaging thereon with an indirectly or directly driven rotary shaft. The rotary shaft (W) of the rotary drive (D) is structurally integrated into the main bearing (H) of the hinged component (S, K) of the vehicle top system whereby the main bearing (H) is provided with a receiving or bearing structure (2) for the rotary shaft (W) of the rotary drive (D) to create a simple construction, which produces a constant moment while requiring a small mounting space and having a low weight and which is possibly suited for any swing angle in principle.

### BACKGROUND OF THE INVENTION

1. Field of the Invention

The invention relates to an actuation arrangement for hinged components of vehicle tops, particularly convertible top hoops or covers for convertible tops, whereby the hinged components are pivotably mounted on the vehicle on at least one main bearing and which actuation arrangement has at least one direct or indirect rotary drive engaging thereon with an indirectly or directly driven rotary shaft.

2. The Prior Art

For actuation of vehicle top elements, e.g., the convertible top hoops or also the lids for the convertible top storage space, there are traditionally employed fluid drives in form of working cylinders which are joined with one end to the vehicle body and with the other end—mainly the outer end of the piston rod—they engage the component to be moved. The hinged components themselves are supported on the vehicle by one or several bearings. The top for convertible automobiles have thereby typically one main bearing that swivably receives the various hoops, among others, and which represents the main pivot point for the hinged component. These main bearings are traditionally made of stamped sheet metal parts or are made by aluminum die casting, especially in case of convertible tops. This approach is in general customary also for covers of convertible tops and for sections of the top that swivel against one another, in particular on hardtops or similar designs.

However, this approach has some disadvantages, for example, in that many mounting borings and borings for operational purposes have to be provided. There are also many secondary pivot points which have to be reinforced in most cases and which considerably influence the kinematics of the hinged component. For example, the larger forces are needed often times at the beginning and at the end of the movements, which demands are, however, not met sufficiently based on the possible arrangement of the working cylinder in the region of the swiveling axis. The produced moment is also not constant during the rotating motion based on the deflection. All this leads also to an increased weight of the entire system, higher (manufacturing) demands, and higher costs.

Another proposal disclosed in DE 198 47 983 C1 relates to a vehicle having a multipart retractable top that consists of at least two top elements. They are swivable against one another and are connected with at least one element to the vehicle whereby hinges are provided to connect top elements with one another and to the vehicle body and whereby at least one hinge per connection may be driven (powered). However, the approach disclosed in DE 198 47 983 C1 proposes a design in which the housing, holding the drive or at least the driven shaft of the hinge, is attached to the vehicle top element—in particular, the one top element that is connected to the vehicle body whereby only a brace joined rigidly to the driven shaft is attached to the vehicle body itself. This type of a swivable connection has naturally the disadvantage that the larger and also the heaviest part is mounted to the hinged top element, and that the top element must meet special demands relative to mechanical stability and rigidness to guarantee exact movement; which demands greatly limit the freedom in design.

It was therefore the object of the present invention to design an actuation arrangement of the type described above in such a manner that the aforementioned disadvantages are avoided. A simple design is to be created that produces a constant moment requiring a small mounting space and having a low weight, and which is possibly suited (to operate) principally at any swing angle.

### SUMMARY OF THE INVENTION

To achieve this object, the actuation arrangement is characterized by the fact that the rotary shaft of the rotary drive is structurally integrated into the main bearing of the hinged component of the vehicle top system whereby the main bearing is provided with a receiving or bearing structure for the rotary shaft of the rotary drive. Thereby, complicated arrangements requiring a large mounting space having a lever systems or the like are avoided since possible mounting borings and borings for operation as well as secondary pivot points may also be advantageously integrated into the main bearing.

Pivoting movements of the actuated components may be performed along essentially any angle range together with essentially uniform kinematics at a small mounting space—and therefore also in the (driver's) head region of the convertible tops, for example.

According to an additional characteristic of the invention, the rotary shaft of the rotary drive lies in the swiveling axis of the hinged component and thereby the principle axis is the main bearing at the same time whereby the rotary shaft is non-rotatably connected to the hinged component—possibly via an interconnected lever. Totally uniform kinematics at a highly compact design is thereby guaranteed.

According to an additional characteristic of the invention, the rotary drive is disposed advantageously at least partly, but preferably as a whole, inside the main bearing whereby the least possible mounting space is required.

When the main bearing is furthermore made of an extruded section, then simple manufacturing and simple as well as economical integration of the drive into the main bearing can be achieved thereby.

According to a first inventive embodiment of the invention, the rotary drive is provided with a hydraulic motor which driven shaft is connected to a rotary shaft for the hinged component—possibly via preferably mechanical gears. This version makes possible a compact and a constructional simple design.

An additional simplification, reduction of the number of necessary components, and reduction in size of the arrangement is possible when the rotary drive is provided with a hydraulic motor which driven shaft is the rotary shaft for the hinged component at the same time.

The rotary drive is advantageously designed as a rotary piston motor in a housing having at least one rotary piston that is swivable on a rotational axis between two strokes by means of a pressure medium, whereby the rotation axis of one or each rotary piston is preferably the rotary shaft at the same time. Thereby, a large effective surface influenced by the pressure medium may be obtained in a compact design while still having a high amount of power.

The piston of the rotary piston motor is thereby preferably designed in the shape of a vane (wing) whereby said vane is held in place non-rotatably on the rotation axis.

The actuation arrangement, according to the invention, is functional and simpler relative to the achievement of the necessary sealing qualities of the working chambers of the hydraulic cylinder when, according to an additional characteristic of the invention, the fluid drive is provided with a linear working cylinder which piston rod rotates the rotary shaft via mechanical gears during its linear working stroke. Linear drives are problem-free in their production and operation and they are suitable for heavy use over a long period. The targeted forces for all applications are sufficiently large with a correspondingly large cross-sectional dimension of the piston.

According to a very simple and operational safe preferred embodiment, the piston rod is designed in form of a toothed rack, at least at its outer end, or it is rigidly connected with a toothed rack. A pinion gear engages the teeth of the toothed rack whereby the pinion gear is non-rotatably attached to the rotary shaft.

It is advantageously proposed in a configuration of the above actuation arrangement, particularly in an outer edge area or a corner area of the component to be moved, that the pinion gear is attached to one end of the rotary shaft and the other end of the rotary shaft is non-rotatably connected to the movable component. Coupling of the hinged component of the convertible top system is thereby made possible from only one direction, which is perpendicular to the longitudinal axis of the actuation arrangement and thereby its installation into the side areas of the vehicle is possible.

According to an additional characteristic of the invention, the toothed rack is guided in a guide track in a longitudinal direction whereby said guide track is adjustably mounted preferably in the direction of the pinion gear—preferably by means of screws. The play between the teeth may thereby be adjusted accurately and, if necessary, minimized or avoided at all.

Optimum protection for the actuation arrangement itself and thereby an unrestricted and trouble free operation is provided, as well as protection from injuries for users or protection for other items from damage by the actuation arrangement, is also provided when the piston rod, the section of the rotary shaft cooperating therewith, and all interconnected components are under one cover.

Protection of this type may be achieved in a simple manner by means of a cover, if this cover is an extension of the housing or the barrel of the hydraulic cylinder.

According to another inventive embodiment, the cover may be formed by the main bearing or components thereof.

Another mechanical conversion of the movement of any fluid drive into a suitable rotary motion of the rotary shaft is made possible in that the hydraulic motor and the rotary shaft are connected by a mechanical worm gear whereby this configuration allows relatively small cross-sectional dimension of the arrangement across its longitudinal axis and it allows the conversion of high-speed rotations into slower rotations occurring at a smaller angle range.

Orientation of the rotary shaft in a larger angle range is possible relative to the longitudinal axis of the hydraulic cylinder or the drive shaft or each hydraulic motor, and possible is also a displacement of these components if the hydraulic motor and the rotary shaft are connected via bevel gears.

The actuation arrangement, according to the invention, may be employed very advantageously as replacement for conventional hinges if the rotary shaft supports, at least partly, the hinged component directly or indirectly through at least one lever, which is firmly connected to said hinged component. Aside of the small space requirement of the fluid drive, compared to the usual hinges, for example, the often times unfavorable force distribution of hinges may be avoided and a better and smoother course of movement for the hinged component may be achieved.

The invention is described in more detail in the following description with the aid of preferred embodiment examples, which are illustrated in the accompanying drawings.

### BRIEF DESCRIPTION OF THE DRAWINGS

FIG. 1 shows thereby a schematic illustration of an actuation arrangement according to the invention.

FIG. 2 is an enlarged side view of the main bearing with the integrated rotary drive of FIG. 1.

FIG. 3 shows a frontal view of the main bearing of FIG. 2.

FIG. 4 is a longitudinal view through the main bearing with the integrated rotary drive of FIG. 2.

### DETAILED DESCRIPTION OF THE PREFERRED EMBODIMENTS

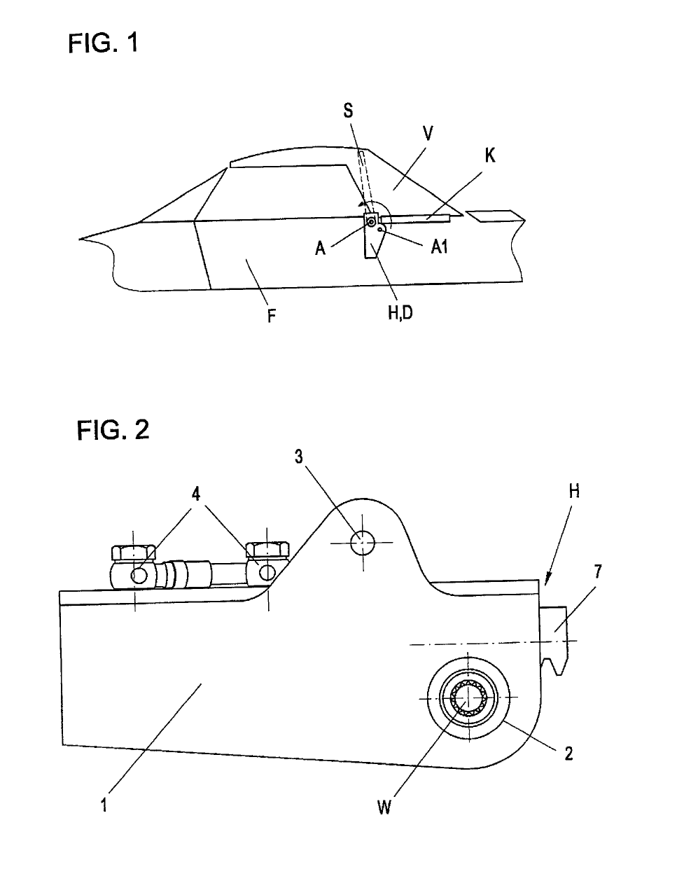

In FIG. 1 there is the main bearing H of the top V attached to the body of the vehicle F. In the main bearing H there is the hoop S of the top V rotatably mounted on the swiveling axis A, for example, whereby in the main bearing H at least one rotary drive D is integrated for the top V and possibly also for additional swivable components of the vehicle F, as mentioned further below. The swiveling axis A1 of the covering lid K of the top V may be preferably disposed within the main bearing H. Actuation of the covering lid K may be performed by a rotary drive integrated in a main bearing or by a separate drive.

The rotary shaft W of the rotary drive D, which is integrated in the main bearing, lies in the swiveling axis A of the respective vehicle component to be actuated—preferably at least the hoop S of the top V. The rotary shaft W may also carry at least part of the weight of the vehicle component actuated thereby or it may directly form its rotation axis A or A1.

The rotary drive D, which is integrated into the main bearing H, advantageously replaces thereby the traditional bearing of the named component and their drives, which often times have an unfavorable bearing, and the rotary drive D requires less space since all bearings and drives may be completely substituted by the main bearing H. Even though this is not shown in FIG. 1, the inventive actuation arrangement may also be employed, for example, at the connection of two vehicle top components and which may thereby be pivoted against one another.

One embodiment example for an inventive main bearing H with an integrated rotary shaft D—particularly a fluid drive with a linear hydraulic motor—is shown in FIG. 2 through FIG. 4 and it will be subsequently described.

The main bearing H consists preferably of an extruded section having two side pieces 1, which are preferably arranged essentially horizontal and parallel to one another. Pairs of aligned openings 2, 3 are provided in the side pieces 1, respectively, which receive the rotation axes of the swivable vehicle component hinged to the main bearing H or which serve to allow joining of additional components. The rotary shaft W of the rotary drive D is preferably guided through an opening 2 whereby the rotary shaft W may be non-rotatably connected to the hinged component of the vehicle top system. The opening 3 defines a secondary rotation axis, for example. Furthermore, in FIG. 1 there may also be seen the ports 4 for the working medium of the rotary drive D, preferably designed as a fluid drive and in particular as a hydraulic motor.

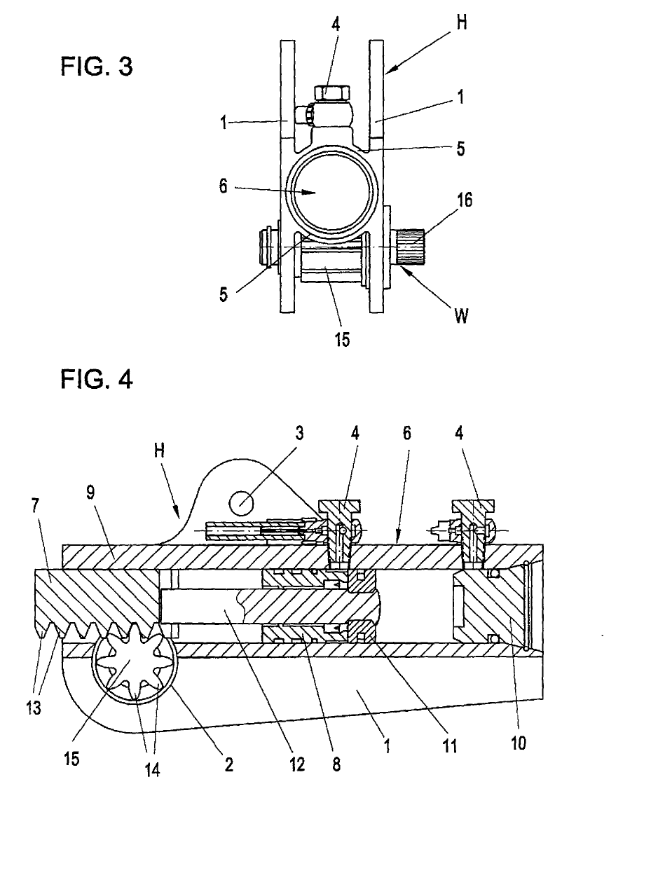

As it can be clearly seen in FIG. 3, the two side pieces 1 of the main bearing H are connected with one another by sections 5, which are running perpendicular to the side pieces 1, whereby the sections 5 form a receiver for the rotary drive D by themselves or together with the side pieces 1. The sections 5 may possibly be part of the drive's housing or the like. In the illustrated embodiment example, the rotary drive D is formed by a linear hydraulic working cylinder 6 which is non-rotatably connected to the rotary shaft W by a toothed rack 7. Thereby it is preferably proposed that the cylinder barrel, having a preferably circular cross section, is formed by the side pieces 1 and the sections 5 of the main bearing H running perpendicular thereto.

In the central region of the main bearing H there is a front cover 8 for the hydraulic cylinder 6. The main bearing H is preferably provided with an extension 9 as an extension of the cylinder barrel of the hydraulic cylinder 6 whereby the extension represents a housing formed by the adjacent front cover 8, the side pieces 1, and the sections 5 running perpendicular thereto, and in which housing the toothed rack 7 is guided. On the side of the front cover 8 and opposite the extension 9 there is provided a bottom cover 10 for the cylinder, which could be possibly designed as one piece with the main bearing H as well. A piston 11 is axially displaced inside the cylinder barrel by means of the working medium being supplied and discharged via the ports 4 and thereby the piston rod 12, which is firmly attached to the piston 11, is also moved and is guided through the front cover area 8 in a sealed manner whereby the piston rod protrudes into the housing formed by the extension 9. The extension 9 preferably contains a guide track for the toothed rack 7 or forms a guide track by itself.

The toothed rack 7 is connected to the piston rod 12 so it cannot be pulled or pushed, for example by a detachable connection in form of a disk-shaped end of the piston rod 12 whereby said disk-shaped end is slidably retained in a groove of the toothed rack 7, which has a narrow slot, whereby the end may be moved perpendicular to the longitudinal direction. Jamming of both of these parts is also avoided in this manner.

The teeth 13 of the toothed rack 7 mesh with the teeth 14 of a pinion gear 15, which is non-rotatably attached to the rotary shaft W and which in turn is mounted in the opening 2 of the side pieces 1 of the main bearing—preferably in possibly two bracket-type parts thereof—whereby the rotary shaft is rotatably mounted and oriented perpendicular to the longitudinal axis of the hydraulic cylinder 6 and the toothed rack 7. The rotary shaft W is preferably provided at its outer end with teeth 16 so that a lever or a hinged top component S, K of the vehicle itself may be non-rotatably connected to the rotary shaft W in a simple manner. However, the non-rotatable connection could be produced also in any other form and/or in a non-positive manner.

To positively avoid turning or wedging of the toothed rack 7 and to ensure secure meshing with the pinion gears 15, the guide of the toothed rack 7 in the extension 9 is advantageous as well since a separate guide track may be advantageously removed from the extension 9 and the toothed rack 7 may be lifted away from the pinion gears 15, and subsequently the detachable connection between the toothed rack 7 and the piston rod 12 may be loosened so that the parts may be separated. During operation, a possible separately inserted guide track is held in place and fixed in the extension 9 by preferably a plurality of worm screws. The guide track may also be adjusted in the direction given by the longitudinal axis of the screws.

An additional advantage of the fluid drive is, in all applications, the simple connection to a rotation sensor which may be connected to the control electronics of the actuation arrangement for control and monitoring of the movement of the hinged components S, K of the vehicle top system. For example, the rotation sensor may be directly coupled to the rotary shaft W or to the driven shaft of any hydraulic motor—or the rotation sensor may be directly mounted thereto or cooperate with the component.

Other transmissions between the toothed rack 7 and the rotary shaft W are also possible, for instance, worm gears or bevel gears, which are especially of advantage when the rotary shaft W is not supposed to stand exactly vertical relative to the longitudinal axis of the hydraulic cylinder 6, or when angles not equal 90° are required or displacements between piston rod 7 and rotary shaft W are required.

Other types of rotary drives are also possible, for example a rotary drive D in form of a rotary piston cylinder whereby a shaft is rotatably mounted in a housing, which is at the same time also the rotary shaft W of the rotary drive D and which is preferably provided with teeth or a similar or functionally equally effective connection configuration to the hinged component. A piston in the shape of a vane (wing) is non-rotatably mounted on the rotary shaft W inside the rotary piston cylinder whereby the vane divides the interior of the housing into two working chambers, which in turn are influenced by the pressure medium whereby the vane is moved and turns the rotary shaft W about its axis in this way.

In place of the above-described and in the drawing illustrated version, all other types of hydraulic motors may be employed in principal, such as rotary geared motors, wing-cell motors, axial- or radial piston motors, or linear-operating thrust piston motors—also without a piston rod but acting upon a lever, which converts the transferred force into a rotating motion with a shaft that is non-rotatably connected to a lever. The drive shaft of the hydraulic motors may also be connected to the rotary shaft W of the hinged component S, K via worm gears or bevel gears and/or via reducing gears or transmission gears, preferably on a mechanical basis; however, said drive shafts may also be directly the rotary shaft W itself.

The rotary shaft W may naturally be engaged not only by a fluid drive but there can be provided a plurality of parallel drives to create higher moments, for instance. Two linear drives may act upon the rotary shaft via separate gears, for example, or said linear drives may engage the same gear to increase the existing moment. As an additional example, it would be conceivable that a rotary shaft W is provided for each pinion gear on top of each other and disposed at opposite sides of the toothed rack, preferably parallel to each other, and which are moved by the piston rod of a respective linear working cylinder, which in turn are preferably also disposed parallel to each other.

We claim:

1. An actuation arrangement for hinged components of vehicle tops, particularly convertible top hoops or covers for convertible tops whereby said hinged components are pivotably mounted on the vehicle on at least one main bearing and which actuation arrangement has at least one direct or indirect rotary drive engaging thereon with an indirectly or directly driven rotary shaft, characterized in that the rotary shaft (W) of the rotary drive (D) is structurally integrated into the main bearing (H) of the hinged component (S, K) of the vehicle top system whereby said main bearing (H) is provided with a receiving or bearing structure (2) for the rotary shaft (W) of the rotary drive (D).

2. An actuation arrangement according to claim 1, wherein the rotary shaft (W) of the rotary drive (D) lies in the swiveling axis (A) of the hinged component (S, K) and thereby the principle axis is the main bearing (H) at the same time whereby the rotary shaft (W) is non-rotatably connected to the hinged component, possibly via an interconnected lever.

3. An actuation arrangement according to claim 1, wherein the rotary drive (D) is disposed at least partly, but preferably as a whole, inside the main bearing (H).

4. An actuation arrangement according to claim 1, wherein the main bearing (H) is made of an extruded section.

5. An actuation arrangement according to claim 1, wherein the rotary drive (D) is provided with a hydraulic motor which driven shaft is connected to a rotary shaft (W) for the hinged component (S, K), possibly by preferably mechanical gears.

6. An actuation arrangement according to claim 1, wherein the fluid drive (D) is provided with a hydraulic motor which driven shaft is preferably the rotary shaft (W) for the hinged component (S, K) at the same time.

7. An actuation arrangement according to claim 6, wherein the fluid drive is designed as a rotary piston motor in a housing having at least one rotary piston, which is swivable on a rotary axis between two strokes by means of the pressure medium, whereby the rotation axis of one or each rotary piston is preferably also the rotary shaft (W).

8. An actuation arrangement according to claim 7, wherein the piston of the rotary piston motor is designed in form of at least one vane (wing) and whereby said vane is non-rotatably held in place on the rotation axis.

9. An actuation arrangement according to claim 5, wherein the rotary drive (D) is provided with a linear working cylinder (6) which piston rod (12) actuates said rotary shaft (W) via mechanical gears (7, 15) during its linear working stroke.

10. An actuation arrangement according to claim 9, wherein said piston rod (12) is designed in form of a toothed rack, at least at its outer end, or it is rigidly connected to a toothed rack (7), and wherein a pinion gear (15) meshes into the teeth of said toothed rack (7) whereby said pinion gear (15) is non-rotatably attached to said rotary shaft (W).

11. An actuation arrangement according to claim 10, wherein said pinion gear (15) is attached to one end of said rotary shaft (W) and wherein the second end of said rotary shaft W) is non-rotatably connected to the movable component (S, K).

12. An actuation arrangement according to claim 11, wherein said toothed rack (7) is guided in a guide track in the longitudinal direction, and wherein said guide track is preferably mounted adjustably in the direction of the pinion gear (15), preferably by means of screws.

13. An actuation arrangement according to claim 12, wherein said piston rod (12), the section of said rotary shaft (W) cooperating therewith, and all interconnected components are under one cover (9).

14. An actuation arrangement according to claim 13, wherein said cover (9) is an extension of said hydraulic cylinder (6).

15. An actuation arrangement according to 13, wherein said cover (9) is formed by the main bearing (H) or components of the main bearing.

16. An actuation arrangement according to claim 1, wherein said hydraulic motor (6) and said rotary shaft (W) are connected to one another via mechanical worm gears.

17. An actuation arrangement according to claim 1, wherein said hydraulic motor (6) and said rotary shaft (W) are connected to one another via bevel gears.

18. An actuation arrangement according to claim 1, wherein said rotary shaft (W) supports, at least partly, the hinged component (S, K) directly or indirectly through at least one lever (H) that is firmly connected to said hinged component (S, K).

19. An actuation arrangement according to claim 1, wherein a rotation sensor is provided, which is preferably coupled with said rotary shaft (W) or the rotary axis of the rotary drive (D).
